(19) United States
(12) Patent Application Publication
(10) Pub. No.: US 2023/0055827 A1
(43) Pub. Date: Feb. 23, 2023

(54) Privacy Device for a Bathroom Stall

(71) Applicant: Meghedie Dersarkissian, Fort Rucker, AL (US)

(72) Inventor: Meghedie Dersarkissian, Fort Rucker, AL (US)

(21) Appl. No.: 17/888,693

(22) Filed: Aug. 16, 2022

Related U.S. Application Data
(60) Provisional application No. 63/235,057, filed on Aug. 19, 2021.

(51) Int. Cl. E06B 9/24; E06B 7/28

(52) U.S. Cl. CPC E06B 9/24; E06B 7/28

(57) ABSTRACT

A device for covering a gap within a public restroom stall to provide privacy to a user. The privacy device includes a strip of a disposable material having a first end and an opposing second end. A pull tab with an adhesive backing is positioned at each end of the strip to secure the strip to the restroom stall. The pull tabs allow a user to easily place the privacy device over the gap. In operation the strip can be unrolled or otherwise removed from a container and aligned over the gap, vertically. The first and second ends of the strip are adhered to the stall, over the gap. Once the user is finished in the stall, the user pulls the tabs to remove the adhesives, along with the strip, from the stall. The privacy device is then disposed of in a trash receptacle.

### CROSS REFERENCE TO RELATED APPLICATION

This application claims the benefit of U.S. Provisional Application No. 63/235,057 filed on Aug. 19, 2021. The above identified patent application is herein incorporated by reference in its entirety.

### BACKGROUND OF THE INVENTION

The present invention relates to privacy devices. The privacy device is adapted to cover a gap within a public restroom stall to prevent other people from peering through the gap.

Public restrooms typically provide bathroom stalls aligned in a row. Each bathroom stall is formed from a door and adjacent partitions or sections that connect with a neighboring stall. Unfortunately, gaps are formed between each door and an adjacent partition due to hinges, door locks, and other fasteners required to maintain the bathroom stall structure and operation. These gaps can vary in size and allow a bathroom stall user to be uncomfortable with the gaze of another person waiting directly outside of the stall to use the bathroom. At times, lines are formed leaving many people the opportunity to peer through the gap of the stall. The lack of perceived privacy can lead the user within the stall to become very uncomfortable and sometimes unable to use the bathroom as intended.

There are some devices that exist that can be installed or retrofitted onto a bathroom stall to cover the gap when the door to the stall is closed. However, these devices are required to be installed by a bathroom facility owner or operator and are not disposable. Other devices exist that can cover the gap but are to be transported with the user after use. However, these devices are not intended to be disposed of, making the continuous use unsanitary or require constant cleaning thereof. Therefore, there exists a need for a privacy device that comprises a strip of material having a pull tab with an adhesive backing configured to secure the strip over the gap of the bathroom stall.

In light of the devices disclosed in the known art, it is submitted that the present invention substantially diverges in design elements and methods from the known art and consequently it is clear that there is a need in the art for an improvement for a privacy device for a bathroom stall. In this regard the instant invention substantially fulfills these needs.

### SUMMARY OF THE INVENTION

In view of the foregoing disadvantages inherent in the known types of privacy devices now present in the known art, the present invention provides a new privacy device wherein the same can be utilized for conveniently covering the gaps within a bathroom stall.

It is an objective of the present invention to provide a privacy device comprising a strip of material having a first end and an opposing second end, wherein the strip of material is configured to extend vertically over a gap of a bathroom stall.

It is another objective of the present invention to provide a privacy device comprising a pull tab extending from each end of the strip, wherein the pull tabs allow a user to easily place and remove the privacy device over the gap.

It is yet another objective of the present invention to provide a privacy device comprising an adhesive backing extending on a rear side of each pull tab, wherein the rear side of each pull tab is adapted to be placed on a surface of a bathroom stall so as to secure the strip thereto.

It is yet another objective of the present invention to provide a privacy device intended for an interior side of a bathroom stall, allowing the user to strategically apply the privacy device over the gap.

It is therefore an object of the present invention to provide a new and improved privacy device for a bathroom stall that has all of the advantages of the known art and none of the disadvantages.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a rear view of an embodiment of the privacy device.

FIG. 2 shows a front view of a pull tab of the privacy device.

FIG. 3 shows a front view of an adhesive layer of the privacy device.

FIG. 4 shows a front view of a peelable strip of the privacy device.

FIG. 5 shows a perspective view of an embodiment of the privacy device in use.

### DETAILED DESCRIPTION OF THE INVENTION

Reference is made herein to the attached drawings. For the purposes of presenting a brief and clear description of the present invention, the preferred embodiment will be discussed as used for covering a gap extending vertically along a bathroom stall. The figures are intended for representative purposes only and should not be considered to be limiting in any respect.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation.

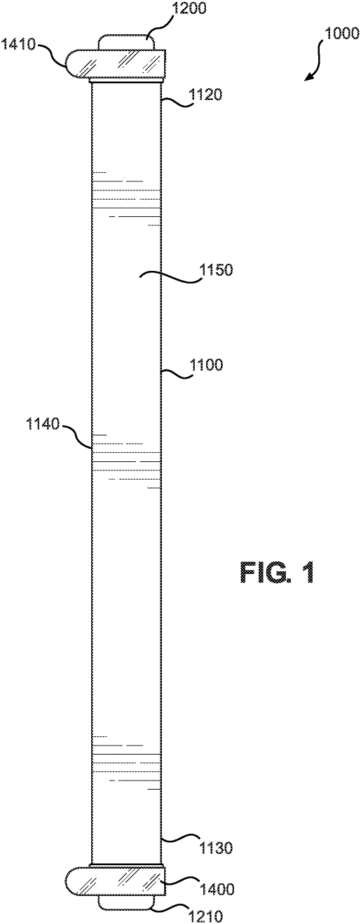

Referring now to FIG. 1, there is shown a rear view of an embodiment of the privacy device. The privacy device 1000 comprises a strip of a material 1100 having a first end 1120, an opposing second end 1130 and a pair of lateral sides 1140, wherein the strip 1100 is configured to cover a gap formed vertically within a bathroom stall of a public restroom. The lateral sides of the strip 1100 form a width adapted to extend entirely over a width of the gap formed within the bathroom stall. In the illustrated embodiment, the strip 1100 comprises a rectangular shape having a width of 3 inches and a length of 55 inches. In alternate embodiments, the strip 1100 comprises a width ranging from 0.5 to 5 inches and a length ranging from 10 inches to 60 inches. In other embodiments, the strip comprises any suitable width and length capable of covering a gap formed within a bathroom stall. In some embodiments, the length and/or width of the strip is customizable such that the unneeded width or length can be separated from the strip and later reused. In this embodiment, the strip 1100 comprises a perforated seam running along an entire length and/or width to allow the separation thereof.

In the illustrated embodiment, the strip 1100 is composed of a thin, light weight paper material that is disposable, such as tissue paper. The strip 1100 is configured to fold or bend as the user manipulates the privacy device. The strip 1100 is also configured to crumple for disposal. In some embodiments, the strip is biodegradable and flushable. In the illustrated embodiment, the strip is made of a single layer of material to prevent bulkiness or additional thickness. In this way, the privacy device 1000 can be packaged and stored efficiently in a stacked configuration. In other embodiments, the strip 1100 comprises a water-proof top layer that prevents the strip from deterioration prior to use if an exposed side of the strip 1100 contacts a liquid. The exposed side will be the side of the strip 1100 that is visible or closest to an opening of a package used to contain a plurality of privacy devices. In some embodiments, the exposed side is the front side of the strip and in other embodiments, the rear side of the strip.

The material of the strip 1100 is solid and non-transparent or, in some embodiments, opaque, to prevent persons from outside the bathroom stall from viewing persons or shadows within the bathroom stall. In some embodiments, the strip 1100 comprises indicia thereon, such as an alignment marker to provide guidance to the user when placing the strip over a gap. The alignment markers are positioned on each side of the strip, a specified distance from a lateral side, to indicate placement of strip over the gap. For example, if a user positions one lateral side of the strip beyond the alignment marker, the opposing lateral side of the strip will not be able to contact to opposing side of the bathroom stall forming the gap. In some embodiments, the alignment marker is a vertical line marking. However, in other embodiments, the alignment marker can be any suitable indicia to indicate a stopping point for aligning a first lateral side over a gap.

The privacy device can be stored individually in a rolled or folded configuration. In alternate embodiments, the privacy device is stored with a plurality of privacy devices within a package. The package is configured to be storable in a user’s purse or pocket. In other embodiments, the package is adapted to remain in a public restroom having large gaps within the bathroom stall.

The rear side 1150 of the strip 1100 is configured to be positioned over the gap such that the lateral edges of the rear side 1150 of the strip 1100 are capable of contacting a respective side of the bathroom stall forming the gap. In the illustrated embodiment, the rear side of the strip does not have any adhesive directly on the strip that is capable of adhering the rear side of the strip directly to the stall.

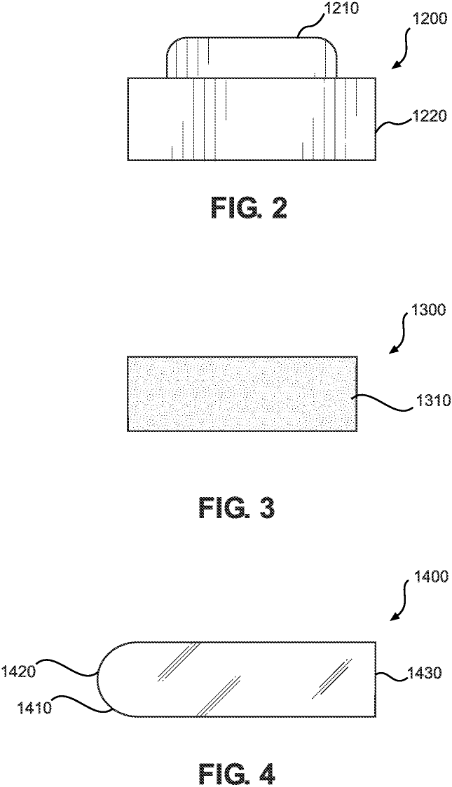

Referring now to FIGS. 1 and 2, there is shown the rear view of an embodiment of the privacy device and a front view of a pull tab of the privacy device, respectively. A pull tab 1200 is disposed at each end 1120, 1130 of the strip 1100. Each pull tab 1200 comprises a first section 1210 configured to be gripped by the user and a second section 1220 that receives an adhesive backing thereon. The first section 1210 of the pull tab 1200 extends from the distal most ends of the strip 1100 to allow the user to easily maneuver the strip 1100 and place it over the gap. The first section 1210 comprises a width smaller than the width of the strip 1100 to allow for easier grasping of the first section 1210 through the gap area when secured to the bathroom stall. In the illustrated embodiment, the second section 1220 is wider than the first section 1210 and extends the substantial width of the strip 1100 or between the lateral sides 1140 of the strip 1100. The width of the second section 1220 is configured to provide stability and structural support to the privacy device 1000 to prevent the strip 1100 from tearing as the user manipulate the privacy device 1000 by handling the first section 1210.

In the illustrated embodiment, only the first section 1210 is visible from a front view of the privacy device. The second section 1220 is covered by the strip 1100 when from the front view. The upper edges of the first section 1210 are rounded to provide a comfort to the user when forming a pincer grasp with the pull tab 1200. The second section 1220 comprises a rectangular shape to mimic the ends of the strip 1100. The front side of the second section 1220 is secured to the strip 1100. In the illustrated embodiment, the second section is fastened to the strip 1100 by an adhesive. In some embodiments, the second section 1220 comprises a width larger than the width of the strip 1100. In the illustrated embodiment, the pull tabs 1200 are formed of a rigid, non-adhesive material, such as plastic.

Referring now to FIGS. 1 and 3, there is shown the rear view of an embodiment of the privacy device and a front view of an adhesive layer of the privacy device, respectively. The adhesive backing 1300 is positioned along a substantial area of the rear side of the second section of the pull tab 1200, wherein the adhesive backing 1300 is configured to secure the strip 1100 to the bathroom stall. In the illustrated embodiment, the adhesive backing 1300 comprises a rectangular shape and terminates along the same edges as the second section of pull tab 1200. In the illustrated embodiment, the entire rear side 1310 of the adhesive backing 1300 is covered with an adhesive fastener. The adhesive fastener is configured to adhere to metal, plastic, or other material stalls. When the adhesive backing is released from the bathroom stall, the adhesive fastener is configured to release while not tearing the tissue paper or material of the strip 1100 when removed. In some embodiments, the adhesive backing is positioned only along the lateral sides of the second section of the pull tab 1300. In this way, the adhesive backing will not be positioned directly over void space or the gap, but only securing to the sides of the bathroom stall forming the gap. In the illustrated embodiments, the adhesive intended to fasten the privacy device 1000 to the bathroom stall is only disposed on the adhesive backing or is the adhesive backing. This prevents additional areas of the privacy device from inadvertently adhering to itself or other unwanted areas.

Referring now to FIGS. 1 and 4, there is shown the rear view of an embodiment of the privacy device and a front view of a peelable strip of the privacy device, respectively. In the illustrated embodiment, the adhesive backing comprises a peelable cover 1400 to protect the adhesive until the privacy device 1000 is ready for use. The peelable cover 1400 is easily removed to expose the adhesive on the adhesive backing. A first side 1410 of the peelable cover 1400 comprises an extension member 1420 that protrudes beyond a first lateral side 1140 of the strip 1100. This extension member 1420 of the peelable cover 1400 is rounded and allows a user a convenient area to grasp and separate the peelable cover 1400 from the adhesive backing. A second end 1430 of the peelable cover 1400 terminates along the same edge the corresponding side of the adhesive backing, such that the peelable cover 1400 covers the adhesive backing completely. In the illustrated embodiment, the peelable cover 1400 is a release liner composed of any suitable material, such as paper coated with a silicone polymer, adapted to easily release from the adhesive backing when peeled therefrom.

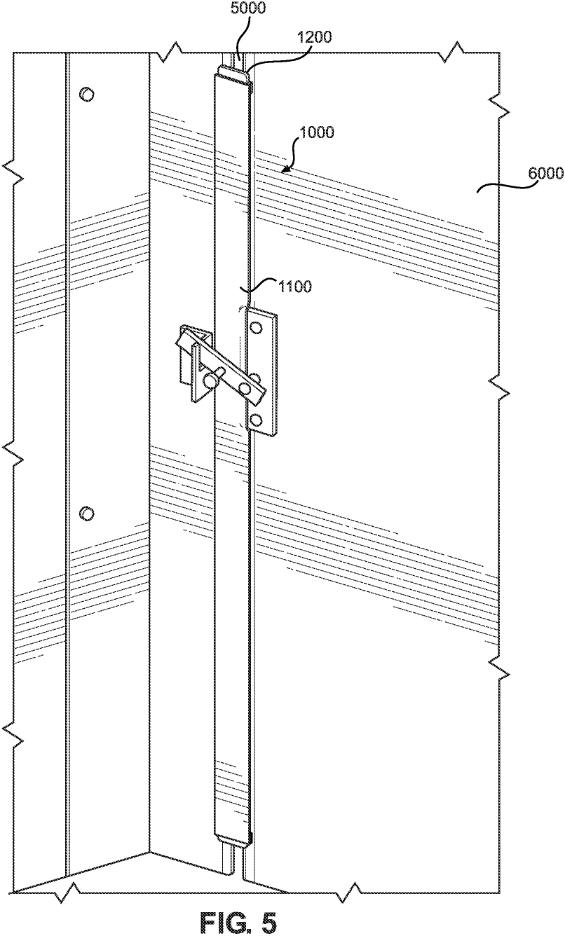

Referring now to FIG. 5, there is shown a perspective view of a front side of an embodiment of the privacy device in use. In operation, the privacy device 1000 can be unrolled or otherwise removed from a container or packaging and vertically aligned over a gap 5000 formed between partitions of a bathroom stall 6000. The peelable cover is removed from the adhesive backing at the first end of the strip 1100 and applied to an end of the stall, over the gap, and then the peelable cover at the second end of the strip 1100 is removed and applied to the opposing end of the stall, over the gap. The first section of both pull tabs 1200 remain exposed and once the user is finished in the stall, the user pulls the pull tabs 1200 to separate the adhesive backing from the stall 6000. The privacy device 1000 is then disposed.

In use, the privacy device is intended to be placed on an interior of the bathroom stall by the user of the stall. In this way, the user can strategically place the strip over the gap or portions of the gap that the user would like to prevent someone on the other side of the stall from seeing through. This also enables the user to conceal his or her activity and make it unknown to a person standing on the other side of the stall that the user is applying the privacy strip.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A privacy device, comprising:
a strip of material having a first end and an opposing second end;
a first pull tab extending from the first end and a second pull tab extending from the second end of the strip;
an adhesive backing disposed on a rear side of each pull tab, wherein the adhesive backing is configured to be adhered to a surface of a bathroom stall;
a peelable cover removably disposed over each adhesive backing;
wherein a width of the strip is configured to extend over an entire width of a gap formed between partitions of a bathroom stall.

2. The privacy device of claim 1, wherein the adhesive backing is a single-use, and the strip is composed of a biodegradable material, such that the privacy device is disposable.

3. The privacy device of claim 2, wherein the strip is foldable and composed of tissue paper.

4. The privacy device of claim 3, wherein the strip comprises a single layer of material.

5. The privacy device of claim 1, wherein each pull tab comprises a first section and a second section, wherein the first section extends beyond the distal most ends of the strip and the second section comprises the adhesive backing, wherein the second section is disposed within a boundary of a perimeter of the strip.

6. The privacy device of claim 5, wherein the second section comprises a width greater than a width of the first section of the pull tab.

7. The privacy device of claim 5, wherein only the first section of the pull tab is visible from a front view of the privacy device.

8. The privacy device of claim 1, wherein the first section of the pull tab comprises rounded upper edges.

9. The privacy device of claim 5, wherein the second section comprises a rectangular shape to mimic a shape of the first and second ends of the strip.

10. The privacy device of claim 5, wherein a front side of the second section is fastened to the strip by an adhesive.

11. The privacy device of claim 5, wherein the adhesive backing comprises a rectangular shape and terminates along the same edges as the second section of pull tab.

12. The privacy device of claim 1, wherein an entire rear side of the adhesive backing is covered with an adhesive fastener.

13. The privacy device of claim 1, wherein a first side of the peelable cover comprises an extension member that protrudes beyond a first lateral side of the strip.

14. The privacy device of claim 13, wherein the extension member of the peelable cover is rounded.

15. The privacy device of claim 14, wherein a second end of the peelable cover terminates along a same edge of a corresponding side of the adhesive backing, such that the peelable cover covers the adhesive backing completely.

16. A method for covering a gap disposed vertically along a bathroom stall, comprising: providing a privacy device including:
a strip of material having a first end and an opposing second end;
a first pull tab extending from the first end and a second pull tab extending form the second end of the strip;
an adhesive backing extending on a rear side of each pull tab, wherein the rear side of each pull tab is adapted to be placed on a surface;
wherein the adhesive backing is configured to be adhered to the surface of a bathroom stall;
a peelable cover removably disposed over each adhesive tab;
wherein a width of the strip is configured to extend over an entire width of a gap formed between partitions of a bathroom stall;
removing the peelable cover; adhering the adhesive backing of the first pull tab to the surface of the bathroom stall along an upper end of the gap; adhering the adhesive backing of the second pull tab to the surface of the bathroom stall along a lower end of the gap; covering a length of the gap with the strip; removing the strip by pulling on the first and second pull tabs.
